(19) United States
(12) Patent Application Publication
(10) Pub. No.: US 2026/0091958 A1
(43) Pub. Date: Apr. 2, 2026

(54) ROTOR TURNING LIFTING YOKE

(71) Applicant: LIFTRA IP APS, Aalborg SV (DK)

(72) Inventors: Per Eske FENGER, Terndrup (DK); Alexander Becse CHRISTIANSEN, Hjørring (DK); Ruben Tjell LAMBERTSEN, Gandrup (DK)

(73) Assignee: LIFTRA IP APS, Aalborg SV (DK)

(21) Appl. No.: 19/115,084

(22) PCT Filed: Sep. 26, 2023
(86) PCT No.: PCT/EP2023/076620

§ 371 Date: Mar. 25, 2025

(30) Foreign Application Priority Data
Sep. 26, 2022 (DK) PA202270466

(51) Int. Cl. B66C 1/10; F03D 13/10

(52) U.S. Cl. CPC B66C 1/108; F03D 13/104; F03D 13/139

(57) ABSTRACT

Rotor lifting yoke for lifting a three bladed rotor, said rotor lifting yoke comprising: a lifting structure, a first and second flexible elongated element arranged to be connected both to the lifting structure and to a root portion of a first blade of the rotor, and a third and fourth flexible elongated element arranged to be connected both to the lifting structure and to a root portion of a second blade of the rotor. The rotor lifting yoke further comprises one or more length adjusting mechanisms which are arranged to adjust the effective length of the first and third and/or the second and fourth flexible elongated elements. The flexible elongated members are further arranged such that when said flexible elongated members are attached to the root portions of their respective blades, at least one point on the first and third and/or at least one point on the second and fourth flexible elongated elements is attached to their respective blades via a non-slip attachment. In this way, a rotor lifting yoke is provided which can rotate the rotor from a vertical to a horizontal position and back again in an easy and flexible manner just by adjusting the lengths of the flexible elongated members.

The current invention relates to a rotor lifting yoke for lifting a three bladed rotor of a wind turbine, said lifting yoke comprising a lifting structure which is suitable for being lifted by a crane, a first and second flexible elongated element arranged to be connected both to the lifting structure and to a root portion of a first blade of the rotor, and a third and fourth flexible elongated element arranged to be connected both to the lifting structure and to a root portion of a second blade of the rotor. The first and second flexible elongated elements being arranged such that when they are connected to the root portion of the first blade, the first flexible elongated element is in contact with a rotor tip facing side of the root portion of the first blade and the second flexible elongated element is in contact with a rotor base facing side of the root portion of the blade, and the third and fourth flexible elongated elements being arranged such that when they are connected to the second blade, the third flexible elongated element is in contact with a rotor tip facing side of the root portion of the second blade and the fourth flexible elongated element is in contact with a rotor base facing side of the root portion of the second blade.

### DESCRIPTION OF RELATED ART

Lifting yokes are well known in the art of wind turbine repairs, construction and assembly. Typically, cranes are used to transport components of the wind turbine between the ground and the top of the tower. For example, when exchanging a gearbox, a crane will lift the old gearbox from the nacelle to the ground and then lift a new gearbox from the ground to the nacelle.

However, it is often difficult to connect a crane to the component itself in an easy manner. A lifting yoke is therefore usually provided which is suitable for the component to be lifted. The lifting yoke can then be attached to the component and the crane can then lift the combined lifting yoke and component. In one operation, a lifting yoke is connected to a component on the ground and then the combined lifting yoke and component are lifted to the nacelle via a crane. Or the opposite situation occurs, where a lifting yoke is connected to the component when the component is on the wind turbine and then the combined lifting yoke and component is lowered to the ground.

Some examples of lifting yokes used in the wind turbine industry are disclosed in U.S. Pat. No. 8,960,747, CN108190725 and WO2022112250. These yokes have adjusting mechanisms so that when the lifting yoke lifts the component, the orientation of the component with respect to the yoke, and hence the orientation of the component with respect to the wind turbine, can be controlled and adjusted This allows the same yoke to be used with different components from different manufacturers. For example components of different weight and size will need to be supported by the yoke in different ways so that the component is arranged in the proper orientation with respect to the wind turbine. However, most known yokes are not arranged to allow large variations in orientation.

One particular example of a lifting operation, is the lifting or lowering of a rotor for a wind turbine. This is a complex operation which requires two cranes to turn the rotor as it is lowered to the ground. It should be noted that for the sake of the current specification the term “rotor” refers to a complete rotor blade assembly comprising a rotor hub and blades mounted on the rotor hub.

In the typical procedure for lowering a rotor from the nacelle to the ground, a lifting wire of a first large crane is connected to the rotor either via a rotor lifting yoke and slings which surround the blades or via a dedicated lifting bracket which is bolted to the rotor hub. As the rotor is lowered to the ground, a lifting wire of a second smaller crane is connected to the tip of the downwards pointing blade and is used to lift the tip of the downwards pointing blade such that as the rotor is lowered, the rotor pivots upwardly until the rotor and the blades are horizontally arranged. The rotor can then be set on the ground with the blades extending horizontally outwards from the hub. When lifting the rotor from the ground to the nacelle a lifting wire of a first crane is connected to the rotor, again via a lifting yoke with slings or via a lifting bracket bolted to the rotor. A second crane lifts the tip of the blade which will become the downwards pointing blade. The first crane lifts faster than the second crane and the rotor will then slowly rotate until the rotor and the blades are arranged vertically. However, in both lifting and lowering operations, multiple cranes are needed to rotate the hub from the horizontal position to the vertical position or vice versa.

It should also be noted that there is a risk of damaging the rotor blades with solutions which use slings around the rotor blades, because as the rotor is pivoted, the blade will rotate in the sling causing the rope/strap of the sling to slide relative to the surface of the blade. If the friction between the blade and the rope/strap is high, there could be a risk for damage to the blade as the rope/strap moves differently than the blade itself. Furthermore, if there are attachments on the blade itself, for example vortex generators, or other aerodynamic features, there is a risk that these could be damaged.

One proposed lifting yoke which would avoid the use of two cranes has been disclosed in EP2072812. However, this solution proved to be too complicated to implement as it was too heavy and bulky and the connections between the rotor and the yoke were difficult to implement in a safe and reliable manner. Hence, even though it is described in the patent literature, it has never been implemented in practice. Another proposed solution is disclosed in US2020140236. While this solution appears to be plausible, this solution does not work for a three bladed rotor as the friction between the ropes and the blades are not enough to rotate the rotor. The proposed solution in US2020140236 would however work for a two bladed rotor.

### SUMMARY OF THE INVENTION

It is therefore a first aspect of the current invention to provide a rotor lifting yoke for a three bladed wind turbine rotor which can rotate the rotor from an essentially vertical plane to an essentially horizontal plane and vice versa during a lifting operation.

A second aspect of the current invention is to provide a rotor lifting yoke which is light weight and compact.

A third aspect of the current invention is to provide a rotor lifting yoke which can be used with many different types and sizes of three bladed rotors.

A fourth aspect of the current invention is to provide a rotor lifting yoke which can be used with low risk of damage to the blade.

These aspects are provided at least in part via a rotor lifting yoke according to claim 1. In this way, a rotor lifting yoke is provided which allows for the rotor to be turned from a vertical orientation to a horizontal orientation in an easy manner.

It should be noted that the term “non-slip attachment” is to be understood in this specification as a form of attachment which ensures a constant position between the flexible elongated element and the blade where there is no displacement between the flexible elongated element and the root portion of the blade at the specific location. In some embodiments, the non-slip attachment is provided by a bracket which is fixed to the flexible elongated element and to the root portion of the blade. In some embodiments, the non-slip attachment is provided by friction between a portion of the flexible elongated element and the root portion of the blade. It should be clear that in order to provide a non-slip attachment in the case of a frictional connection, the friction force should exceed the rotation force generated by the weight of the rotor.

In some embodiments, said one or more length adjusting mechanisms is/are remotely controllable during a lifting operation. The term “effective length” in this specification should re-inforce the understanding, that different forms of length adjusting mechanism can be provided which fall with-in the scope of the invention. For example, in some embodiments, the length of the flexible elongated elements is constant, but the end of the flexible elongated elements which is connected to the lifting structure could be displaced instead. In this way, the length of the flexible elongated element is constant, but the effective length of the element will change as the end of the element is displaced. This could for example be by displacing the cross beam to which the end of the flexible elongated element is attached. In such an embodiment, the length is constant, but the effective length is changed.

In some embodiments, the first and second flexible elongated elements are portions of a single flexible elongated element and/or the third and fourth flexible elongated elements are portions of a single flexible elongated element. Hence for example, instead of having separate ropes for the forward and rearward portions of the blade, a single rope could be provided which is in contact both with the forward and rearward parts of the blade.

In some embodiments, the first and second flexible elongated elements are arranged to be connected to the root portion of the first blade via one or more brackets which is/are arranged to be detachably attached to the root portion of the first blade and in that the third and fourth flexible elongated elements are arranged to be connected to the root portion of the second blades via one or more brackets which is/are arranged to be detachably attached to the root portion of the second blade.

In some embodiments, the first flexible elongated element is arranged to be attached to the root portion of the first blade via a first bracket, the second flexible elongated element is arranged to be attached to the root portion of the first blade via a second bracket, the third flexible elongated element is arranged to be attached to the root portion of the second blade via a third bracket and the fourth flexible elongated element is arranged to be attached to the root portion of the second blade via a fourth bracket.

In some embodiments, the first and second flexible elongated elements are arranged to be connected to the root portion of the first blade via a first bracket and in that the third and fourth flexible elongated elements are arranged to be connected to the root portion of the second blade via a second bracket.

In some embodiments, the brackets are arranged to be attached to the root portion of the first and second blades respectively via bolts which connect the root portion of the blade to the rotor hub.

In some embodiments, the rotor lifting yoke further comprises a first and second spacing element, the first and second flexible elongated elements are portions of a single flexible elongated element which is arranged to be wrapped at least 540 degrees around the root portion of the first blade. the third and fourth flexible elongated elements are portions of a single flexible elongated element which is arranged to be wrapped at least 540 degrees around the root portion of the second blade, the first spacing element is arranged to be placed between the first flexible elongated element and the root portion of the first blade when lifting a rotor, the second spacing element is arranged to be placed between the third flexible elongated element and the root portion of the second blade when lifting a rotor and the first and second spacing elements have a dimension perpendicular to the surface of the base portion of the first and second blades respectively of at least 500 mm. In this way, the tension in the first and third flexible elongated elements is reduced. Also undesired rotation of the root portion of the blades relative to the flexible elongated elements is prevented during lifting, since the torque about the centre of gravity of the rotor due to gravity will be reduced. In some embodiment, said distance is greater than 600 mm, greater than 700 mm or greater than 800 mm. In some embodiments, the distance is determined by the size of the rotor which is to be lifted. In some cases, the distance is greater than 20%, greater than 25% or greater than 30% of the diameter of the root portion of the blades of the rotor which is to be lifted.

In some embodiments, the first spacing element is fastened to the first and/or the second flexible elongated elements and the second spacing element is fastened to the third and/or the fourth flexible elongated elements. In this way, movement of the spacing elements relative to the flexible elongated elements is prevented. The term “fastened to” in this specification should be understood in that the two elements are connected together such the location at which the two elements are fastened move together. The term fastened is a displacement constraint in at least one dimension and not necessarily a rotational constraint or a displacement constraint in all directions. One example of a fastening connecting is a loop on the spacing element through which the rope is fed. The spacing element can displace along the rope, however, the loop cannot displace away from the rope. Hence the point of the spacing element which is attached to the loop will remain in a controlled position with respect to the rope, but can slide along the rope. Other forms of fastening could also be imagined.

In some embodiments, the first spacing element is fastened to both the first and the second flexible elongated element such that the first spacing element is a portion of the single flexible elongated element which is arranged to be wrapped at least 540 degrees around the root portion of the first blade and the second spacing element is fastened to both the third and the fourth flexible elongated elements, such that the second spacing element is a portion of the single flexible elongated element which is arranged to be wrapped at least 540 degrees around the root portion of the second blade. In this case, the “single flexible elongated element” may not be flexible along the entire length of the element, but the element will still be able to be wrapped around the root portion of a blade.

In some embodiments, the first and the second spacing elements comprise a blade facing surface having a curvature which is fitted to the curvature of the root portion of the blade. In this way, the forces between the spacing element and the root portion of the blade can be distributed over an area. In some embodiments, the length of the blade facing surface is greater than 400 mm, greater than 500 mm or greater than 600 mm.

In some embodiments, during a lifting operation, the first flexible elongated element is in contact with the first spacing element at the point where the first spacing element extends furthest from the surface of the root portion of the first blade and the third flexible elongated element is in contact with the second spacing element at the point where the second spacing element extends furthest from the surface of the root portion of the second blade.

In some embodiments, the first and second spacing elements are arranged such that during a lifting operation and when the rotor is in a horizontal position, the horizontal distance between the center of the root portion of the first blade and the first flexible elongated member in the plane of the diameter of the root portion of the first blade is at least 70% of the diameter of the root portion of the first blade and the horizontal distance between the center of the root portion of the second blade and the third flexible elongated member in the plane of the diameter of the root portion of the blade is at least 70% of the diameter of the root portion of the second blade.

In some embodiments, the rotor lifting yoke is arranged such that during a lifting operation where the rotor lifting yoke is lifting a rotor, at least a portion of the first or the second flexible elongated element and at least a portion of the third or the fourth flexible elongated element are in contact with a portion of the root portions of the first and second blades respectively which is located underneath the centre of the root portion of the respective blade.

In some embodiments, the non-slip attachment between the flexible elongated element and the root portion of the blade is located on the root portion of the blade which is on or below the line which connects the rotor tip facing side of the blade and the rotor base facing side of the root portion of the blade. In some embodiments, the non-slip attachment between the first and/or third flexible elongated element and the root portion of the blade is located at a point which is arranged past the rotor tip facing side in a direction pointing from the rotor tip facing side towards the rotor base facing side and in that the non-slip attachment between the second and/or the fourth flexible elongated element and the root portion of the blade is located at a point which is arranged past the rotor base facing side in a direction pointing from the rotor base facing side towards the rotor tip facing side.

In some embodiments, the length adjusting mechanism comprises one or more winch mechanisms connected to one or more of the first, second, third or fourth flexible elongated members. In some embodiments, the winch mechanism(s) comprises a motor and a pulley. In some embodiments, the motor is a hydraulic motor. In some embodiments, the motor is an electric motor. In some embodiments, the power to the motor is supplied via a battery attached to the lifting yoke. In the case where the motor is a hydraulic motor, a hydraulic power supply could be powered by a battery driven pump.

In some embodiments, the lifting structure comprises a first and a second cross beam arranged parallel to each other and spaced apart from each other and in that the second and fourth flexible elongated members are connected to the first cross beam and the first and third flexible elongated elements are connected to the second cross beam.

The specification also discloses a crane lifting a rotor via a lifting yoke according to any one or any combination of embodiments described above.

In some embodiments of a crane, at least a portion of the first and/or the second flexible elongated members is in contact with a root portion of the first blade and in that at least a portion of the third and/or the fourth elongated members is in contact with a root portion of the second blade.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1 shows a perspective view of a schematic wind turbine tower where the rotor is being lowered by a crane and a rotor lifting yoke according to a first embodiment of the invention.

FIG. 2 shows a close-up partial perspective view of the rotor lifting yoke and rotor of FIG. 1.

FIG. 3 shows a close-up partial perspective view of the rotor lifting yoke and the rotor of FIG. 1, in a lower position and partially rotated.

FIG. 4 shows a close-up partial perspective view of the rotor lifting yoke and the rotor of FIG. 1, in an even lower position and fully rotated such that the rotor and blades are horizontally arranged.

FIG. 5, shows a close-up partial perspective view of a wind turbine tower, rotor and rotor lifting yoke according to a second embodiment of the invention.

FIGS. 6 and 7 schematically show the vertical and horizontal positions of a rotor respectively with a third embodiment of a rotor lifting yoke according to the invention.

FIGS. 8 and 9 schematically show the vertical and horizontal positions of a rotor with a fourth embodiment of a rotor lifting yoke according to the invention which is similar to the one shown in FIG. 5.

FIGS. 10 and 11 schematically show the vertical and horizontal positions of a rotor with a fifth embodiment of a rotor lifting yoke according to the invention which is similar to the one shown in FIGS. 1 to 4.

FIGS. 12 and 13 schematically show the vertical and horizontal positions of a rotor being lifted by a sixth embodiment of a rotor lifting yoke according to the invention.

FIGS. 14 and 15 schematically show the vertical and horizontal positions of a rotor being lifted by a seventh embodiment of a rotor lifting yoke according to the invention.

FIG. 16 schematically shows the vertical position of a rotor being lifted by an eighth embodiment of a rotor lifting yoke according to the invention.

### DETAILED DESCRIPTION OF THE EMBODIMENTS

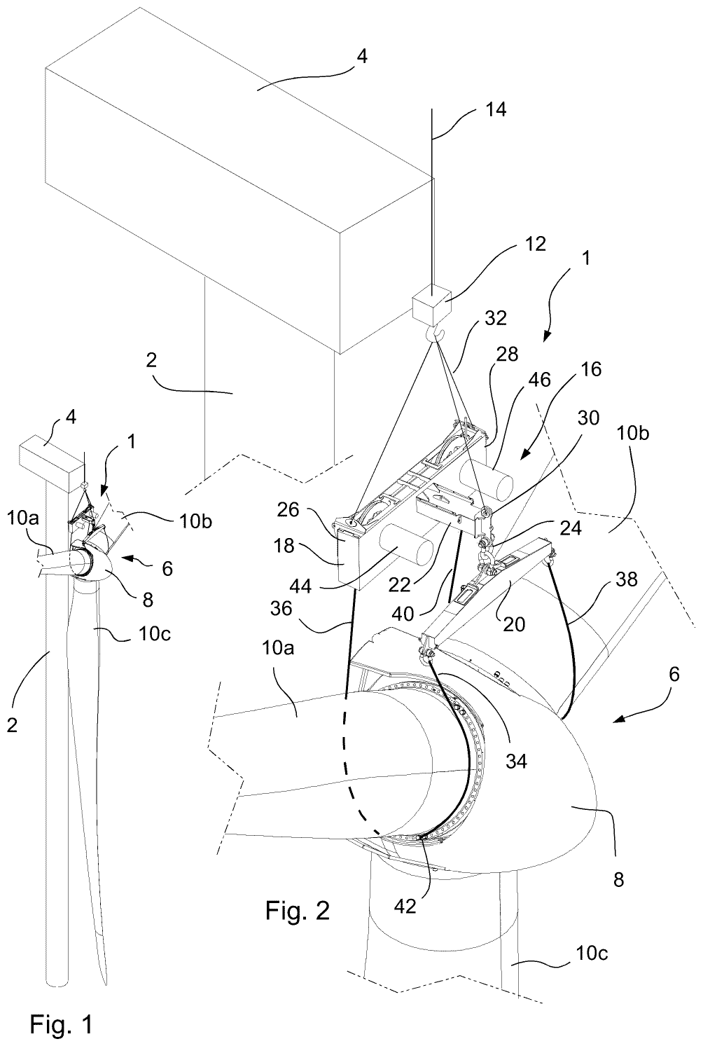

FIGS. 1 to 4 schematically illustrate a first embodiment of a rotor turning lifting yoke 1 according to the current invention in operation.

The figures schematically show a wind turbine tower 2, a nacelle 4 and a rotor 6. The rotor comprises a rotor hub 8 and three blades 10a, 10b, 10c attached to the rotor hub 8. A crane hook 12 lifted by a crane wire 14 of a crane (not shown) is used to lift the rotor via the lifting yoke 1.

The lifting yoke comprises a lifting structure 16 in the form of a first cross beam 18 and a second cross beam 20. The second cross beam is arranged parallel to the first cross beam and at an offset to the first cross beam. The offset is ensured by an offset beam 22 attached to the first cross beam and extending perpendicularly therefrom. The second cross beam is pivotably supported at the end of the offset beam 22 by a shackle connection 24. The ends 26, 28 of the first cross beam and the end 30 of the offset beam spaced away from the first cross beam are connected to slings or cables 32 which are connected to the lifting hook 12 of the crane. As the crane moves the lifting hook up and down, the lifting structure 16 will therefore also move up and down.

The lifting yoke further comprises a first rope 34 and a second rope 36 attached to a first blade 10a and a third rope 38 and a fourth rope 40 attached to a second blade 10b. The first and third ropes 34 and 38 are also attached near opposite ends of the first cross beam and the second and fourth ropes 36, 40 are also attached near opposite ends of the second cross beam. In this embodiment, a bracket 42 is bolted to the bolt ring which connects the first blade to the hub. A second bracket (hidden from view) is bolted to the bolt ring which connects the second blade to the hub. The first and second ropes are attached to the first bracket 42 and the third and fourth ropes are attached to the second bracket. In this way, the ropes are fixed in position with respect to the root portion of the respective blades they are attached to at the location of the brackets.

In this embodiment, the first cross beam further comprises two winch assemblies 44, 46. A first winch assembly 44 is connected to one end of the second rope 36 and the second winch assembly 46 is connected to one end of the fourth rope 40. In the current embodiment, the winch assemblies are driven by battery powered electric motors which can be remotely controlled. As the winch assemblies operate, the length of the second and fourth ropes can be adjusted.

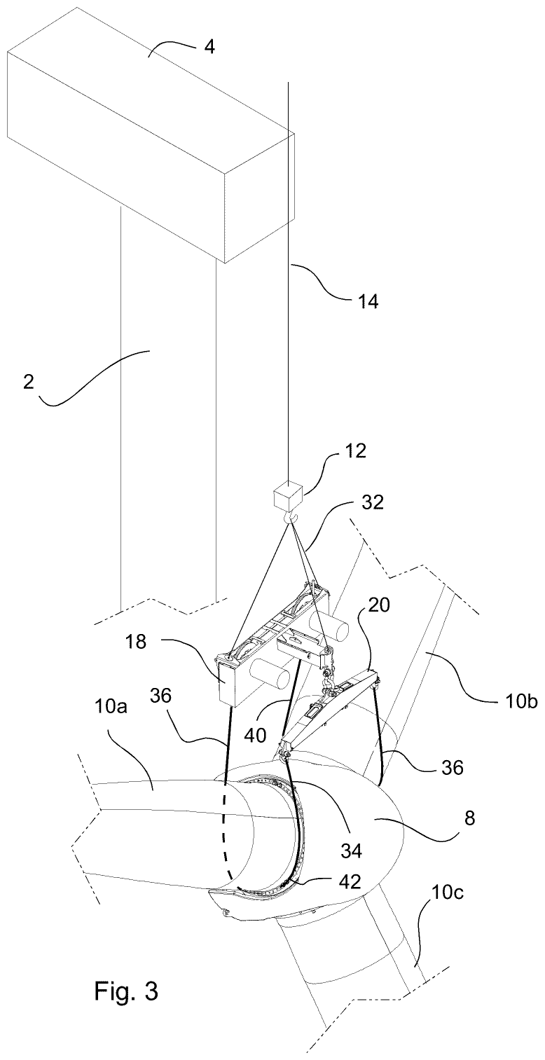

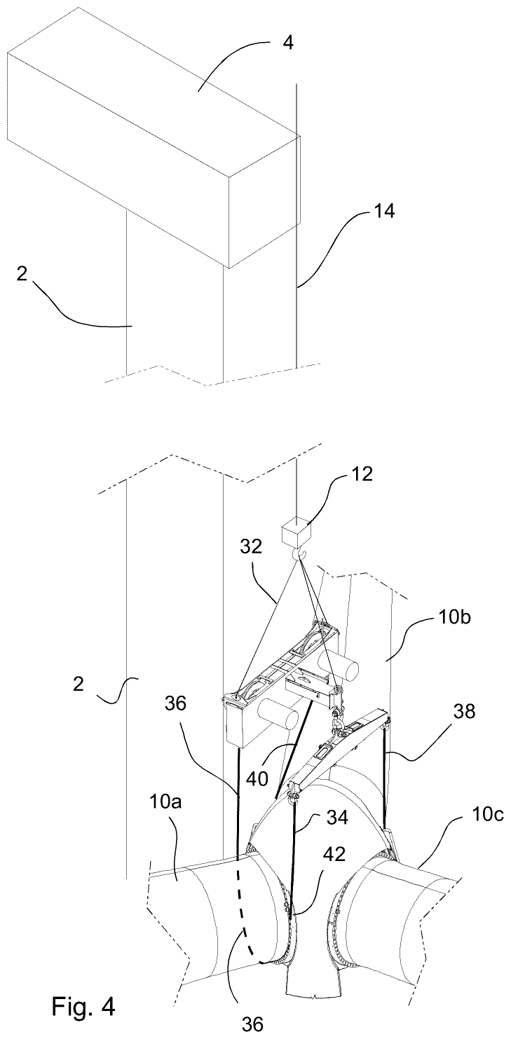

When the length of the second and fourth ropes are adjusted, the rotor will rotate since the first, second, third and fourth ropes are fixed in position with respect to the rotor. In FIG. 2, the rotor is arranged hanging such that it is arranged in an essentially vertical plane. In FIG. 3, the length of the second and fourth ropes has been increased. This causes the rotor to rotate outwardly and the downward pointing blade starts to pivot outwardly away from the wind turbine tower. In FIG. 4, the length of the second and fourth ropes has been increased even further, thereby rotating the rotor such that it is arranged essentially in a horizontal plane. In this position, the rotor base is arranged essentially horizontally and is arranged facing downwards. In this position, the rotor can be set on the ground or on a support structure on the ground. The entire operation can be performed via a single crane without the need for a separate crane to pivot the tip of the downwards pointing blade outwardly.

It should be clear to the person skilled in the art, that different mechanisms and arrangements can be provided which control the relative lengths of the ropes. For example, a winch mechanism could be attached to the first and third ropes instead of the second and fourth ropes. In this example, the length of the first and third ropes would need to be decreased to get the same rotation as in FIGS. 1-4. In another example, a winch mechanism could be connected to all four ropes. In this example, the first and third ropes could be shortened and the second and fourth ropes lengthened. In another example, the shackle connection between the offset beam 22 and the second cross beam 29 could be formed as part of a winch mechanism which could lengthen or shorten the distance between the first and second cross beams. In this example, the lengths of the ropes between the cross beams and the rotor would be constant, but the distance between the two cross beams would be variable. The person skilled in the art will understand that different solutions are possible.

It should be noted that in this embodiment, while difficult to see in the figures, the bracket 42 is an arc shaped metal plate which has a plurality of bolt holes corresponding to the bolt pattern of the bolts which connect the blade 10a to the rotor hub. When it is desired to attach the bracket to the blade, some of the bolts which connect the blade to the hub are removed, the bracket put into place and then the bolts are inserted through the bracket, through the blade and into the hub. An end of the first and second ropes is then attached at opposite ends of the bracket 42. The same procedure is then repeated for the second blade 10b and the third and fourth ropes.

Another feature to be noted in the current embodiment, is that the second cross beam 20 is pivotably supported at the end of the offset beam 22 with respect to the first cross beam 18. In this way, the beam will pivot and will automatically balance the loads in the ropes 34, 38 attached between the second cross beam 20 and the first and second blades 10a, 10b. If the second cross beam had been fixed relative to the first cross beam, then there could be a difference between the loads in the ropes attached to the first and second blades. However, when the beam is pivotably attached to the crane support, then the loads will be automatically balanced.

In certain rotors, the bolts which connect the blade to the rotor hub are not accessible. In this cases it is not easy to attach a bracket to the root portion of the blade directly. In these situations, one way of establishing a non-slip connection between a rope and the root portion of the blade is to increase the friction between the rope and the root portion of the blade to which the rope is connected. One way of doing this is to increase the coefficient of friction of the material of the rope with respect to the material of the root portion of the blade. For example, the rope could be covered with a rubber like substance which has a high coefficient of friction with respect to the fiberglass material of the root portion of the blade. As the length of the ropes are adjusted, the surface of the root portion of the blades will follow the ropes and the rotor will be pivoted as in the case where the ropes are fixed to the rotor via a bracket. It should be clear to the person skilled in the art, that the geometry of the rotor and the location of the ropes on the blades will have a large effect on the torque force on the rotor during the turning operation. In the case where the rotor is hanging in a vertical plane, the torque forces will be quite low as the rotor will be balanced. However, as the rotor is pivoted, the centre of gravity will change. If the centre of gravity is offset in a horizontal plane from the centre of the root portions of the first and second blades, the torque force which seeks to pivot the third blade downwardly, will increase. In this case, the friction between the blade and the rope will need to be higher to maintain the position of the rotor. The expected torque force is easy to calculate based on the known geometry of the rotor. The friction force can also be easily calculated by the coefficient of friction and the expected normal force based on the weight of the rotor. Hence, suitable materials and sized of the ropes can be determined.

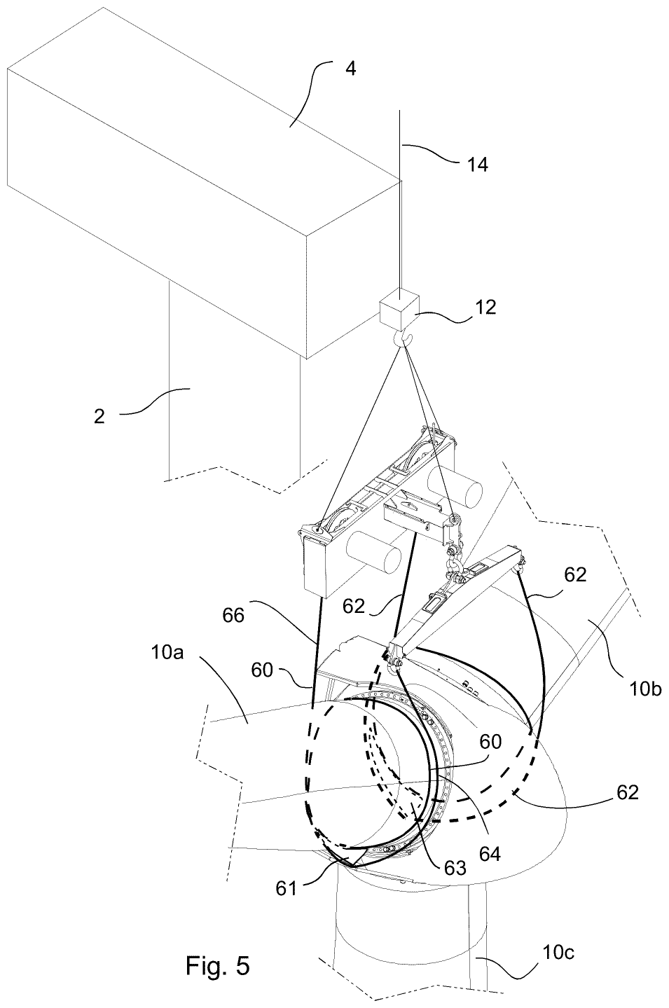

In another embodiment, as shown in FIG. 5, a first single continuous rope 60 is wrapped 540 degrees around the root portion of the first blade 10a and a second single continuous rope 62 is wrapped 540 degrees around the root portion of the second blade 10b. In this way, as the rotor is lifted, the ropes will tighten around the root portion of the blades to increase the fictional force between the blade and the rope. In certain cases (not shown), the rope could be wrapped two or even more times around the root portion of the blade to even further increase the amount of contact between the rope and the blade. In the figure, a first spacing element 61 is arranged between the first blade 10a and the first single continuous rope 60 and a second spacing element 63 is arranged between the second blade 10b and the second single continuous rope 62. The function of the spacing elements is described in more detail with respect to FIGS. 8, 9, 14 and 15.

In another embodiment (not shown), a strap or other form of circular bracket could be tightened around the circumference of the root portion of the blade. For example a strap with a rubber like surface against the surface of the blade could be tightened with a form of ratchet mechanism until the strap is very tightly pressed against the surface of the blade. Ropes as in FIGS. 1-4 can then be attached to the strap via connection points fastened to the strap.

It should be noted that in the case of FIG. 5, a single rope is used on either side of the rotor. However, there is still a forward portion 64 and a rearward portion 66 of the rope. Hence, the forward portion 64 can be considered to be a first flexible elongated element and the rearward portion can be considered to be a second flexible elongated element in the understanding of the claims.

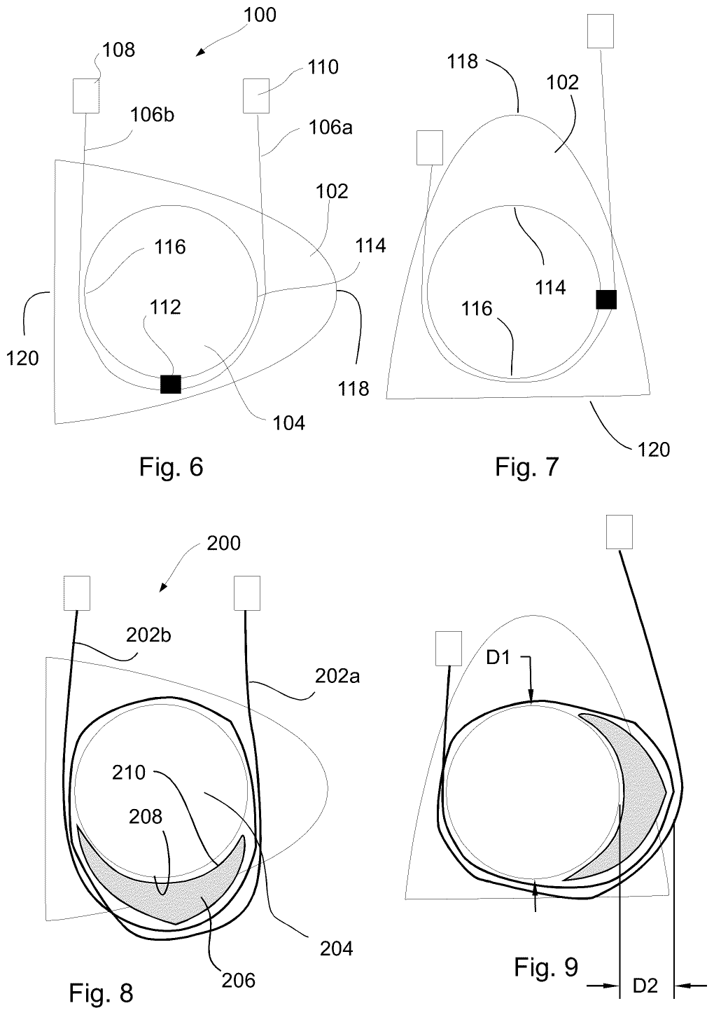

FIGS. 6 and 7 schematically illustrate a third embodiment of a lifting yoke 100 for lifting a rotor of a wind turbine. In this case, the rotor hub 102 is shown and a cross section through the root portion 104 of one blade is shown for illustration purposes. It should be clear to the person skilled in the art that a similar arrangement is provided on the other side of the rotor hub and in connection with a blade on the other side of the rotor hub.

In this embodiment, instead of two separate ropes attached to a bracket on the rotor hub, a single rope 106 is used. One end of the rope 106 is attached to a first cross beam 108 and a second end of the rope is attached to a second cross beam 110. The rope is arranged to pass underneath the root portion of the blade and thereby support the weight of the rotor hub. A bracket 112 is provided which fastens a portion of the rope to a root portion of the blade. This bracket could be arranged in many different ways. In one case, a bracket could be provided which sandwiches a portion of the rope between two plates which both are bolted to the rotor hub via the bolts which connect the blade and the hub.

It should be noted that in this case, even though a single rope is used, the rope could still be considered to comprise two separate elements which are joined together into a single element. A first rope portion 106a which is in contact with the rotor tip facing side 114 of the root portion of the blade and a second rope portion 106b which is in contact with the rotor base facing side 116 of the root portion of the blade. In this embodiment, the bracket is fastened to the blade at a point between the rotor tip facing side and the rotor base facing side and at a point below the centre of the blade. In this way, when the rotor is rotated, the bracket will rotate upwards but remain below the centre of the blade. Had the bracket been attached higher up on the structure, the bracket would rotate up past the centre of the blade and cause extra loading on the ropes. It should also be noted that the dimension of the bracket, the location at which the first rope portion 106a is held relative to the surface of the blade and the geometry of the rotor will have an effect on the tension in the first rope portion 106a when the rotor is held in the horizontal position (FIG. 7). The further the rope is held from the surface of the root portion of the blade, the lower the tension will be in the first rope portion 106a and the higher will be the tension in the second rope portion 106b. This principle applies also to the other embodiments disclosed in this application. By adjusting this distance, the tensions in the individual ropes can be designed more specifically.

It should be noted that the rotor tip facing side 114 is called this because it faces the tip 118 of the rotor hub 102. The rotor base facing side 116 is called this because it faces the base 120 of the rotor hub 102. It should be noted that as the rotor turns, the rotor tip facing side and the rotor base facing side of the blade will rotate as well. Furthermore, it can be seen that one of the ropes is always in contact with either the rotor tip facing side or the rotor base facing side.

It can also be noted that in the embodiment of FIGS. 6 and 7, the ropes between the cross beams and the bracket don't change physical lengths but the positions of the cross beams change, thereby allowing the rotor to turn. In this case, a more complex lifting structure would need to be provided and a mechanism would need to be provided between the lifting structure of the yoke and the cross beams. However, the end effect is the same as adjusting the length of the first and second ropes. Hence, in the claims, it is specified that the effective length of the ropes is adjusted. This should include the case where a cross beam is arranged between the rope and a displacing mechanism and where the ends of the rope are displaced to cause the effective length of the ropes to change.

FIGS. 8 and 9 show a schematic representation of a fourth embodiment of a rotor lifting yoke 200 similar to the one shown in FIG. 5. In this case, the rope 202 is wrapped 540 degrees around the root portion of the blade 204. In this embodiment, no brackets are required, as the frictional forces between the blade and the rope are enough to ensure a non-slip connection between the rope and the blade. In case the friction is not high enough, the rope could be passed an extra time around the blade, thereby being wrapped 900 degrees around the blade. In this embodiment, a spacing element 206 is provided between the rope 202 and the surface 208 of the root portion of the blade 204. In this way the offset between the tip facing rope portion 202a and the surface of the blade is increased. Due to this spacing element, the tension in the tip facing rope portion will be reduced when the rotor is in its horizontal position and the tension in the rotor base facing rope portion 202b will be increased, as the torques on the rotor due to the force of gravity will be spread out more evenly between the two rope portions. Without the spacing element, the tension in the tip facing rope portion will be so high, that it will not be possible to hold the rotor in position due to friction alone. It has been found that the offset D2 from the surface of the root portion of the blade to the portion of the spacing element in contact with the tip facing portion of the rope 202a when the rotor is in the horizontal position, needs to be at least 20% of the diameter D1 of the root portion of the blade. For modern blades, this will typically be greater than 500 mm. As rotors get bigger, the spacing offset D2 will get larger and larger.

The spacing element 206 in the figures is provided with a blade facing surface 210 which is curved to fit the root portion of the blade. In this way, the forces applied to the spacing element by the ropes will be spread out over a larger area on the surface of the root portion of the blade. Also the larger the length of the curved portion 210, and in general, the larger the area of the curved portion in contact with the root portion of the blade, the more stable will be the position of the spacing element. In certain cases, friction increasing coatings could be applied on the blade facing surface of the spacing element to hold the spacing element in place on the surface of the blade. In the current embodiment, the spacing element is arranged as a triangle like structure, however, it should be clear that other embodiments could be provided. As one non limiting example, a spacing element in the form of a T element could be imagine, where the upper portion of the T was curved to fit the curvature of the blade and the base portion of the T was arranged to point downwards when the rotor is in its vertical position. As the rotor turns to the horizontal position, the base portion of the T would turn to point horizontally outwards to also push the tip facing portion of the rope away from the surface of the blade.

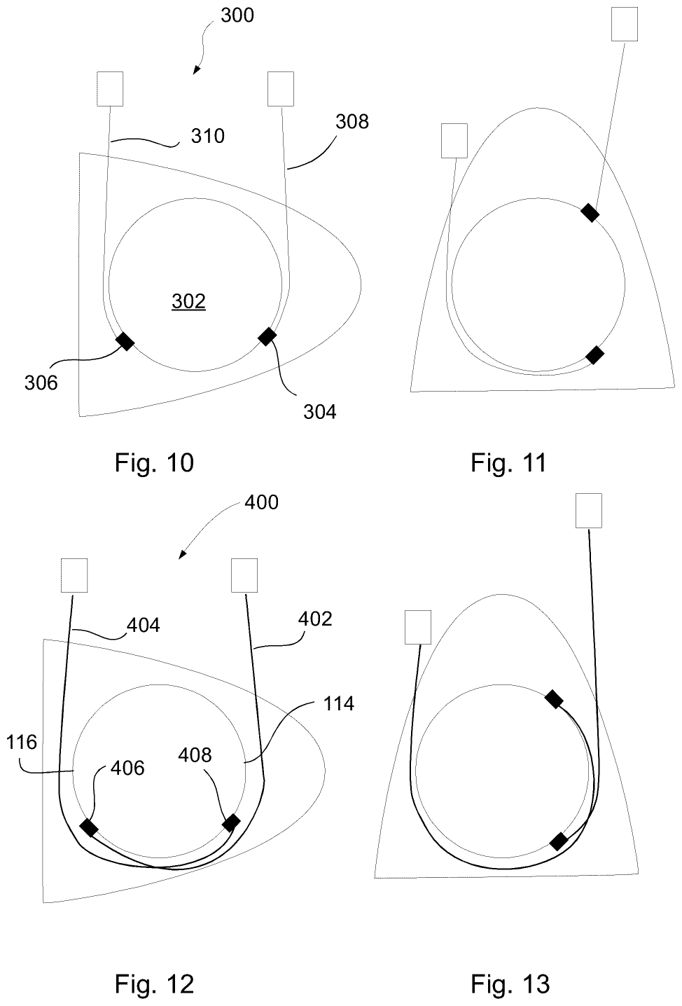

FIGS. 10 and 11 show a fifth embodiment 300 of a lifting yoke. In this example, instead of having one bracket attached to the root portion of the blade, two separate brackets 302, 304 are attached to the root portion of the blade 306. A first rope 308 is attached to the first bracket 304 and a second rope 310 is attached to the second bracket.

FIGS. 12 and 13 show a sixth embodiment 400 of a lifting yoke. In this example, the ropes 402, 404 are again attached to two separate brackets 406, 408 on the root portion of the blade 410, but the ropes cross each other to connect to opposite sides of the root portion of the blade. In this way, the contact surface between the ropes and the blade is increased. This will reduce the force on the brackets themselves and will align the force with the circumference of the blade. In the example of FIGS. 10 and 11, at one position (FIG. 11), the loads will be almost entirely supported by one bracket 304 and the loads will be in a direction which is almost radial to the root portion of the blade. This will require a stronger bracket than the solution of FIGS. 12 and 13.

In this embodiment, it can be said that the bracket 406 connected to the first rope 402 is attached at a point on the root portion of the blade which is located “past” the rotor tip facing side 114 of the root portion of the blade in a direction from the rotor tip facing side 114 of the root portion of the blade towards the rotor base facing side 116 of the root portion of the blade. Likewise, the bracket 408 connected to the second rope 404 is attached to the root portion of the blade at a point located “past” the rotor base facing side 116 of the root portion of the blade in a direction from the rotor base facing side of the blade towards the rotor tip facing side of the blade. In this embodiment, the brackets are located around 135 degrees “past” the respect side of the root portion of the blade. In comparison, in the embodiments in FIGS. 10 and 11, the brackets are located around 45 degrees “past” the respective side of the root portion of the blade. In another embodiment (not shown), the brackets could be located even more than 135 degrees past the respective side of the root portion of the blade.

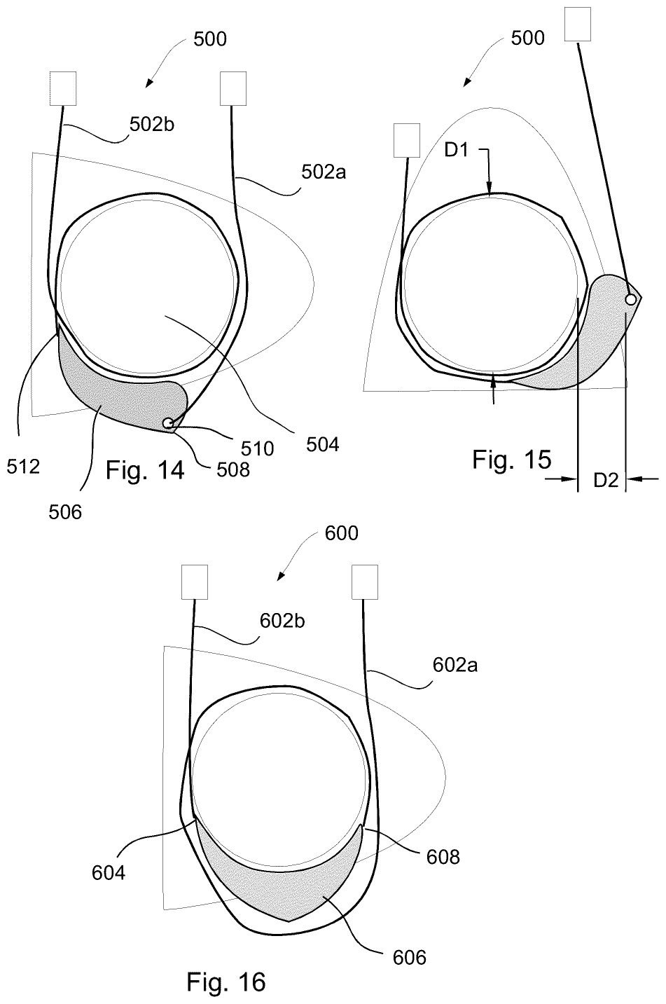

FIGS. 14 and 15 illustrate another embodiment 500 of a rotor lifting yoke similar to the one in FIGS. 8 and 9, however, in this case, instead of having a spacing element between the surface and the rope, the spacing element 506 in this embodiment is an integrated part of the rope element 502. The rotor tip facing portion of the rope 502a is connected to the “highest” part 508 of the spacing element via a fastening member 510. Likewise, the rotor base facing portion of the rope 502b is first wrapped 360 degrees around the root portion of the blade and then attached to one end 512 of the spacing element. In this way, the spacing element is arranged between the rotor base facing portion of the rope 502b and the tip facing portion of the rope 502a. Due to this arrangement, the location of the spacing element can be controlled precisely and held in position by the rope itself.

FIG. 16 illustrates another embodiment 600 similar to the embodiment of FIGS. 14 and 15. In this case, the rotor base facing portion of the rope 602b is first attached to one end 604 of the spacing element 606. Then the tip facing portion of the rope 602a is wrapped around 360 degrees around the root portion of the blade also wrapping around the spacing element and is then attached to the other end 608 of the spacing element 606. As in the other embodiments with spacing elements, when the rotor is rotated to its horizontal position, the spacing element offsets the rotor tip facing portion of the rope 602a from the surface of the blade. This evens out the tensions in the two rope portions and allows the rotor to be rotated and held in a stable position. It should be clear to the person skilled in the art, that the spacing element can be arranged in different ways, and the ropes can be connected or fastened to the spacing element in different ways.

It should be clear that the different concepts described above can be combined in different ways within the scope of the current invention.

In the above discussion, ropes are used between the rotor and the lifting structure. However, it should be clear to the person skilled in the art, that other elements are suitable in this application other than ropes. In the claims the term “flexible elongated element” is used. This should cover ropes, chains, straps, slings, wires, cables, etc. or combinations of these. The person skilled in the art will also be able to provide different options as well as different connection options between the element and the blade. For example, suitable protection elements would be needed if the flexible elongated element was a chain. It should also be noted that the entire “flexible elongated element” does not need to be flexible. It could be that portions of the “flexible elongated element” are stiff, but are shaped to fit the surface of the rotor blade. This is for example, the case in the embodiments of FIGS. 14-16 where the spacing element makes up a portion of the “flexible elongated element”.

It is to be noted that the figures and the above description have shown the example embodiments in a simple and schematic manner. Many of the specific mechanical details have not been shown since the person skilled in the art should be familiar with these details and they would just unnecessarily complicate this description. For example, the specific materials and components used and the specific manufacturing procedures have not been described in detail since it is maintained that the person skilled in the art would be able to find suitable materials, components and suitable processes to manufacture the rotor lifting yoke according to the current invention.

1. Rotor lifting yoke for lifting a rotor of a wind turbine with three blades, said lifting yoke comprising:
a. a lifting structure which is suitable for being lifted by a crane,
b. a first and second flexible elongated element arranged to be connected both to the lifting structure and to a root portion of a first blade of the rotor, and
c. a third and fourth flexible elongated element arranged to be connected both to the lifting structure and to a root portion of a second blade of the rotor,
d. said first and second flexible elongated elements being arranged such that when they are connected to the root portion of the first blade, the first flexible elongated element is in contact with a rotor tip facing side of the root portion of the first blade and the second flexible elongated element is in contact with a rotor base facing side of the root portion of the blade, and
e. said third and fourth flexible elongated elements being arranged such that when they are connected to the second blade, the third flexible elongated element is in contact with a rotor tip facing side of the root portion of the second blade and the fourth flexible elongated element is in contact with a rotor base facing side of the root portion of the second blade,
f. characterized in that the rotor lifting yoke further comprises one or more length adjusting mechanisms which are arranged to adjust the effective length of the first and third and/or the second and fourth flexible elongated elements, and
g. in that the rotor lifting yoke and said flexible elongated members are further arranged such that when said flexible elongated members are attached to the root portions of their respective blades, at least one point on the first and third and/or at least one point on the second and fourth flexible elongated elements is attached to their respective blades via a non-slip attachment.

2. Rotor lifting yoke according to claim 1, characterized in that the first and second flexible elongated elements are portions of a single flexible elongated element and/or in that the third and fourth flexible elongated elements are portions of a single flexible elongated element.

3. Rotor lifting yoke according to claim 1, characterized in that the first and second flexible elongated elements are arranged to be connected to the root portion of the first blade via one or more brackets which is/are arranged to be detachably attached to the root portion of the first blade and in that the third and fourth flexible elongated elements are arranged to be connected to the root portion of the second blades via one or more brackets which is/are arranged to be detachably attached to the root portion of the second blade.

4. Rotor lifting yoke according to claim 3, characterized in that the first flexible elongated element is arranged to be attached to the root portion of the first blade via a first bracket, the second flexible elongated element is arranged to be attached to the root portion of the first blade via a second bracket, the third flexible elongated element is arranged to be attached to the root portion of the second blade via a third bracket and the fourth flexible elongated element is arranged to be attached to the root portion of the second blade via a fourth bracket.

5. Rotor lifting yoke according to claim 3, characterized in that the first and second flexible elongated elements are arranged to be connected to the root portion of the first blade via a first bracket and in that the third and fourth flexible elongated elements are arranged to be connected to the root portion of the second blade via a second bracket.

6. Rotor lifting yoke according to claim 3, characterized in that the brackets are arranged to be attached to the root portion of the first and second blades respectively via bolts which connect the root portion of the blade to the rotor hub.

7. Rotor lifting yoke according to claim 2, characterized in that the rotor lifting yoke further comprises a first and second spacing element, in that the first and second flexible elongated elements are portions of a single flexible elongated element which is arranged to be wrapped at least 540 degrees around the root portion of the first blade, in that the third and fourth flexible elongated elements are portions of a single flexible elongated element which is arranged to be wrapped at least 540 degrees around the root portion of the second blade, in that the first spacing element is arranged to be placed between the first flexible elongated element and the root portion of the first blade when lifting a rotor, in that a second spacing element is arranged to be placed between the third flexible elongated element and the root portion of the second blade when lifting a rotor and in that the first and second spacing elements have a dimension perpendicular to the surface of the base portion of the first and second blades respectively of at least 500 mm.

8. Rotor lifting yoke according to claim 7, characterized in that the first spacing element is fastened to the first and/or the second flexible elongated elements and in that the second spacing element is fastened to the third and/or the fourth flexible elongated elements.

9. Rotor lifting yoke according to claim 7, characterized in that the first spacing element is fastened to both the first and the second flexible elongated element such that the first spacing element is a portion of the single flexible elongated element which is arranged to be wrapped at least 540 degrees around the root portion of the first blade and in that the second spacing element is fastened to both the third and the fourth flexible elongated elements, such that the second spacing element is a portion of the single flexible elongated element which is arranged to be wrapped at least 540 degrees around the root portion of the second blade.

10. Rotor lifting yoke according to claim 7, characterized in that the first and the second spacing elements comprise a blade facing surface having a curvature which is fitted to the curvature of the root portion of the blade.

11. Rotor lifting yoke according to claim 10, characterized in that the length of the blade facing surface is greater than 500 mm.

12. Rotor lifting yoke according to claim 7, characterized in that during a lifting operation, the first flexible elongated element is in contact with the first spacing element at the point where the first spacing element extends furthest from the surface of the root portion of the first blade and in that the third flexible elongated element is in contact with the second spacing element at the point where the second spacing element extends furthest from the surface of the root portion of the second blade.

13. Rotor lifting yoke according to claim 7, characterized in that the first and second spacing elements are arranged such that during a lifting operation and when the rotor is in a horizontal position, the horizontal distance between the center of the root portion of the first blade and the first flexible elongated member in the plane of the diameter of the root portion of the first blade is at least 70% of the diameter of the root portion of the first blade and in that the horizontal distance between the center of the root portion of the second blade and the third flexible elongated member in the plane of the diameter of the root portion of the blade is at least 70% of the diameter of the root portion of the second blade.

14. Rotor lifting yoke according claim 1, characterized in that the rotor lifting yoke is arranged such that during a lifting operation where the rotor lifting yoke is lifting a rotor, at least a portion of the first or the second flexible elongated element and at least a portion of the third or the fourth flexible elongated element are in contact with a portion of the root portions of the first and second blades respectively which is located underneath the centre of the root portion of the respective blade.

15. Rotor lifting yoke according to claim 1, characterized in that the length adjusting mechanism comprises one or more winch mechanisms connected to one or more of the first, second, third or fourth flexible elongated members.

16. Rotor lifting yoke according to claim 1, characterized in that the lifting structure comprises a first and a second cross beam arranged parallel to each other and spaced apart from each other and in that the second and fourth flexible elongated members are connected to the first cross beam and the first and third flexible elongated elements are connected to the second cross beam.
